(19) United States
(12) Patent Application Publication
(10) Pub. No.: US 2003/0103001 A1
(43) Pub. Date: Jun. 5, 2003

(54) Golf distance measuring system and method

(76) Inventors: Charles D. Huston, Austin, TX (US); Darryl J. Cornish, Austin, TX (US)

Correspondence Address: THOMPSON & KNIGHT L.L.P., PATENT PROSECUTION DEPARTMENT, 98 SAN JACINTO BLVD., SUITE 1200, AUSTIN, TX, 78701, US

(21) Appl. No.: 10/341,636

(22) Filed: Jan. 14, 2003

Related U.S. Application Data
(63) Continuation of application No. 08/759,081, filed on Nov. 27, 1996.
(63) Continuation-in-part of application No. 07/804,368, filed on Dec. 10, 1991, now Pat. No. 5,364,093.

(51) Int. Cl. G01S 5/14

(52) U.S. Cl. 342/357.03; 342/357.08

(57) ABSTRACT

A method and system is described for determining the approximate distance from a golf ball to features on a golf course. The system includes a number of GPS receivers attached to carts (or handheld) which display the distance between the feature location and the receiver location. The GPS receiver includes a display of the golf hole being played which shows: the location of the receiver on the hole; the golf cup on the green; hazards on the hole; and the distance to the golf cup or other feature. In a preferred form, a pen input display is used and the player can designate a mark on the display and find out the distance from the receiver to the mark or the distance from the mark to the golf pin. The display preferably shows a distance grid centered about the receiver (or a mark) which allows a quick estimate of distance to the pin hazards, driving distance, target areas, to the group playing ahead, or other features on the hole. With GPS selective availability enabled, a differential error correction or calibration is used which enables distance calculation accuracy to within several meters. Without GPS selective availability, an alternative method and system is described where a calibration procedure yields distance accuracy to within several meters. The system also includes a pro shop monitor where the location of each GPS receiver is shown on the golf course. The method and apparatus of the present invention allows the golfer to accurately select the proper club for the shot, plan a shot strategy for the hole, and to decrease playing time. The pro shop monitor enables the course to marshal play and accept player communications, such as refreshment requests, score inputs, etc.

The present invention is a continuation-in-part of the U.S. patent application Ser. No. 07/804,368 entitled “Golf Distance Measuring System and Method” and a continuation of U.S. patent application Ser. No. 08/759,081 also entitled “Golf Distance Measuring System and Method.”

### BACKGROUND OF THE INVENTION

1. Field of the Invention

The present invention relates to a method and apparatus for determining the approximate distance between a golf ball and a target on the golf course such as the golf cup. In particular, the method and apparatus uses a global positioning satellite receiver positioned near the golf ball to determine the approximate location of the golf ball.

2. Description of Related Art

In the game of golf it is important to know as accurately as possible the distance between the golf ball and the golf cup on the green. It is sometimes also desirable to know the distance between the golf ball and a hazard on the hole being played. Knowing these distances allows proper club selection and allows a player to formulate a hole management plan. For example, a player that knows the ball is 110 yards from the pin would select the appropriate club for 110 yards such as a 9 iron or one of the player's wedges.

Deane Beamon and Jack Nicklaus purportedly pioneered in professional tournament play the use of books containing yardage calculations. Most PGA professionals and serious amateurs now use course yardage books to determine the distance between the ball and the golf cup or a hazard on the hole being played. Yardage books are significantly more accurate than guessing the distance based on a visual inspection.

A significant drawback to the use of yardage books is the fact that the book must be prepared prior to the round of golf. Such preparation is inconvenient for most amateur play in recreational golf. Even when a yardage book is prepared, account must be made for the locations of the tee markers, the location of the golf cup on the green for the particular day, and the position on the hold being played.

There are several alternatives to yardage books for determining the distance from the ball to the golf cup. Most courses mark the hole in some form with approximate distances to the middle of the green. For example, many courses mark the sprinkler heads with distance to the green, while other courses plant trees or post a marker at the 100 or 150 yard position from the middle of the green. Some courses have buried low power location beacons along their fairways and a receiver carried by the golfer receives the nearest beacon signal and indicates the distance of the beacon.

There are several disadvantages to known techniques for distance determination on golf courses. First, they are all have varying degrees of inaccuracy. Typically the distances follow some unknown line in the fairway and are calculated to the middle of the green. Inaccuracies of more than 10 yards are common which unfortunately can be the difference between a 6 foot putt and a sand trap. Second, most known techniques slow play by requiring the player to consult his yardage book or walk around searching for a distance marker and walking off the distance from the marker to the ball. Third, most techniques do not give an indication of the distance to most, if not all, of the hazards. For example, it is important to know the distance the ball needs to travel to carry a trap or water hazard in front of the green.

Therefore, a method and apparatus which could accurately and quickly determine the position of a ball and the distance between the ball and features on the hole being played, such as the golf cup on the green, the preceding cart, or a hazard would contribute to lower scores and faster play. Such a method and apparatus would be particularly advantageous if it also accounted for distance between the ball and an obstacle or hazard.

### SUMMARY OF THE INVENTION

The problems outlined above are generally solved by the method and system of the present invention for determining distance on a golf course. The invention provides a good approximation of the distance from a golf ball to a feature, such as the golf cup, hazard, or preceding golf group. Preferably the system includes a visual display of the golf hole being played, including the location of the pin on the green, the bunkers protecting the green, the hazards on the hole, as well as a digital readout of the distance from the ball to the golf cup. In an enhanced version the display includes a light pen or pointing device (finger or pen for pressure sensitive screen) allowing the player to mark positions on the hole layout. This gives the player the ability to determine distance between the ball and a marked position (a water hazard for example) or distance between a mark and the cup.

Broadly speaking, the method of the present invention includes the steps of positioning a global positioning satellite system (GPS) receiver on the hole being played, determining a position of the remote receiver using the global positioning satellite system, and displaying the distance from the remote receiver to the feature using the position of the remote receiver. Normally the receiver is positioned proximate the golf ball, but alternatively a mark may be made at the ball's approximate location.

The apparatus generally includes a GPS receiver that is positionable on the golf hole. For example, the apparatus might be mounted on a golf cart and the cart may be driven close to the ball. The apparatus also includes a position determining means and a display. Preferably, the determining means is a microprocessor associated with the GPS receiver that calculates an apparent position of the receiver. Alternatively, the determining means may be a microprocessor at a base station and the GPS receiver simply relays or repeats the GPS signals to the base station. The display preferably shows a graphic representation of the hole layout, and in a preferred form is light responsive or pressure sensitive, such as a pen input or touch sensitive display. A distance grid is preferably displayed with its origin at the GPS receiver or alternatively, a mark location.

In a preferred form, the apparent location of the GPS remote receiver is adjusted with an error correction to achieve a corrected location. The difference between the corrected location and the stored location of a feature such as the golf cup is calculated to determine the approximate distance between the ball and the cup. The location of the golf cup is preferably close to the actual location of the current placement of the cup on the green, but may be a nominal location, such as “middle” of the green or “front” of the green.

The error correction is determined by positioning a GPS receiver at a reference location having a known position. The GPS receiver determines an apparent position using the available global positioning satellites in view. The error correction is calculated based on the difference between the apparent position and the known position. The error correction is preferably broadcast periodically for use by the remote GPS receivers used by the golf players. Preferably, the position of the golf cups on the greens are determined by placing a GPS receiver in or near the cup (e.g. before play by the greens keeper), determining an apparent position, and applying the error correction to obtain the golf cup position stored for use during play.

In the preferred embodiment, a base station is placed at the known position to continuously calculate and transmit the error correction. The remote receivers are optionally configured to periodically transmit their position to the base station so that the course marshal can continuously monitor the progress of play.

In an alternative form, the remote receiver is used to calculate an error correction for its own use. For example, a remote receiver mounted on a golf cart would be driven onto a placard designating a known location on each hole. The apparent GPS position of the remote receiver over the placard is compared with the known position to calculate an error correction for use during play.

### BRIEF DESCRIPTION OF THE DRAWINGS

FIG. 1 schematically illustrates the display of the preferred embodiment of the remote unit;

FIG. 2 is a block diagram of a remote unit including a GPS receiver in accordance with the present invention;

FIG. 3 is a block diagram of the base station in accordance with the present invention;

FIG. 4 is a block diagram of a cup locator unit used to locate the position of each golf cup on the respective green;

FIG. 5 is a schematic of the packet radio network used to transmit the error correction;

FIG. 6 is a flow chart depicting the operation of the calibration sequence for determining the error correction;

FIG. 7 comprises the flow charts illustrating the operation of a remote unit in accordance with the system of the present invention, where

FIG. 7A is a flow chart of the calibration sequence,

FIG. 7B is a flow chart of the method for determining the corrected position of the remote unit,

FIG. 7C depicts the method for determining the distance from the cup to the mark A, and

FIG. 7D shows the flow chart for the method for determining the distance marks A and B;

FIG. 8 depicts the layout of an alternative embodiment of the control panel of the remote unit;

FIG. 9 is a block diagram describing an alternative embodiment of the remote unit which includes an internal calibration mechanism;

FIG. 10 is a schematic of an alternative embodiment of the remote unit display showing a golf hole layout;

FIG. 11 illustrates the pro shop monitor of the preferred embodiment; and

FIG. 12 is a block diagram depicting an alternative system where the remote units act as repeaters.

### DESCRIPTION OF THE PREFERRED EMBODIMENTS

The present invention utilizes a global positioning satellite system, such as Navstar or Glonass (GPS) to determine the approximate distance from a golf ball to hole features, such as the cup or pin on the green of the golf hole being played. GPS is a spaced based system of satellites which can provide to an infinite number of receivers accurate three dimensional position (i.e. horizontal location and altitude), velocity, and time. A general understanding of GPS is useful to appreciate the operation of the present invention. Numerous books and articles are available on GPS operation and theory. See e.g., GPS—A Guide to the Next Utility, Trimble Navigation (incorporated by reference for background).

### THE GLOBAL POSITIONING SATELLITE SYSTEM

The GPS system is an umbrella of satellites circling the earth passively transmitting signals. Each satellite has a very accurate atomic clock which is periodically updated. A GPS receiver with an accurate clock can identify a satellite and determine the transit time of the signal from the satellite to the receiver. Knowing the transit time and knowing that the speed of light is 186,000 miles per second enables a calculation of the distance from the satellite to the receiver. The signal carries with it data which discloses satellite position and time of transmission, and synchronizes the aircraft GPS system with satellite clocks.

If a GPS receiver can locate 3 or 4 satellites it can determine its distance from each satellite. The intersection of these 3 or 4 spheres enables a precise location of the receiver (and some compensation for timing errors in the receiver's internal clock). The GPS system should have 21 satellites and 3 spares once the system is fully deployed. Currently about 14 satellites are deployed, giving reasonable satellite coverage worldwide for most of the day.

There are basically two types of GPS receivers—P (precision) code and C/A (coarse availability) code. P code is for government use only and requires specialized equipment. C/A code receivers are becoming widely available with the continuing deployment of GPS satellites. One difficulty with C/A code receivers is that the government from time to time intentionally degrades the satellite signals—so called “selective availability.” With selective availability turned on horizontal accuracy is on the order of 50-100 meters. With selective availability disabled horizontal accuracy can improve to around 15 meters.

### FIRST EMBODIMENT

Turning to the drawings, the system of the present invention includes a remote unit 10, base station 12, and cup locator 14. A remote unit 10 accompanies the golfer during the round—for example mounted on the golf cart.

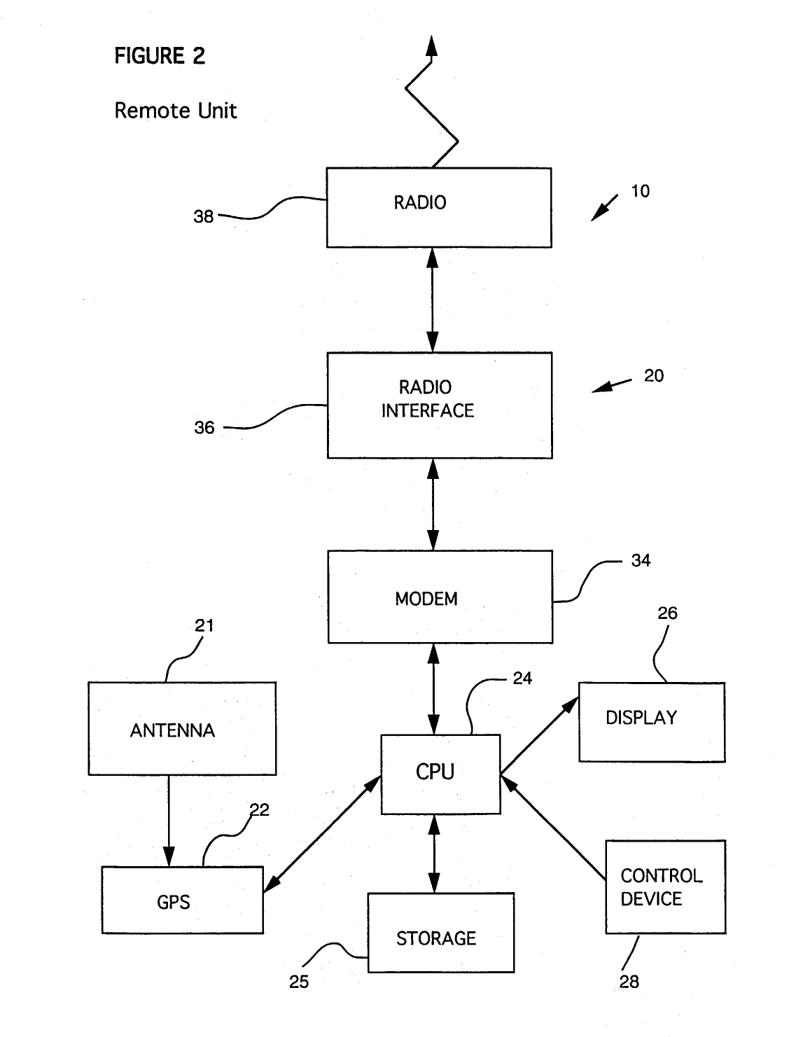

As shown in FIG. 2, the remote unit 10 include a packet radio system 20, a GPS antenna 21 and receiver 22, a CPU 24, storage 25, a display 26, and a control device 28. The GPS receiver 22 is preferably the multi-channel receiver such as the SV-6 Model made by Trimble Navigation of Sunnyvale, Calif. Other commercially available substitutes are acceptable such as made by Magellan or Rockwell/Collins. The antenna 21 is either remote or internal to the receiver 22, but in any event is mounted on the golf cart for an upward look angle for optimum GPS signal reception.

As shown in FIG. 2, the remote unit 10 includes a CPU 24, control device 28, nonvolatile memory storage 25, as well as the radio interface 20 and GPS engine and antenna 22, 21. In the preferred remote unit, the CPU 24, memory storage 25, and display 26 are integral, such as the PDA or pen tablet referenced above, and are collectively referred to as the display 26. The memory storage 25 includes the internal RAM and the PCMCIA cards incorporated with such a PDA or pen tablet. Of course integration or segregation of the components of FIG. 2 is a simple matter of design choice.

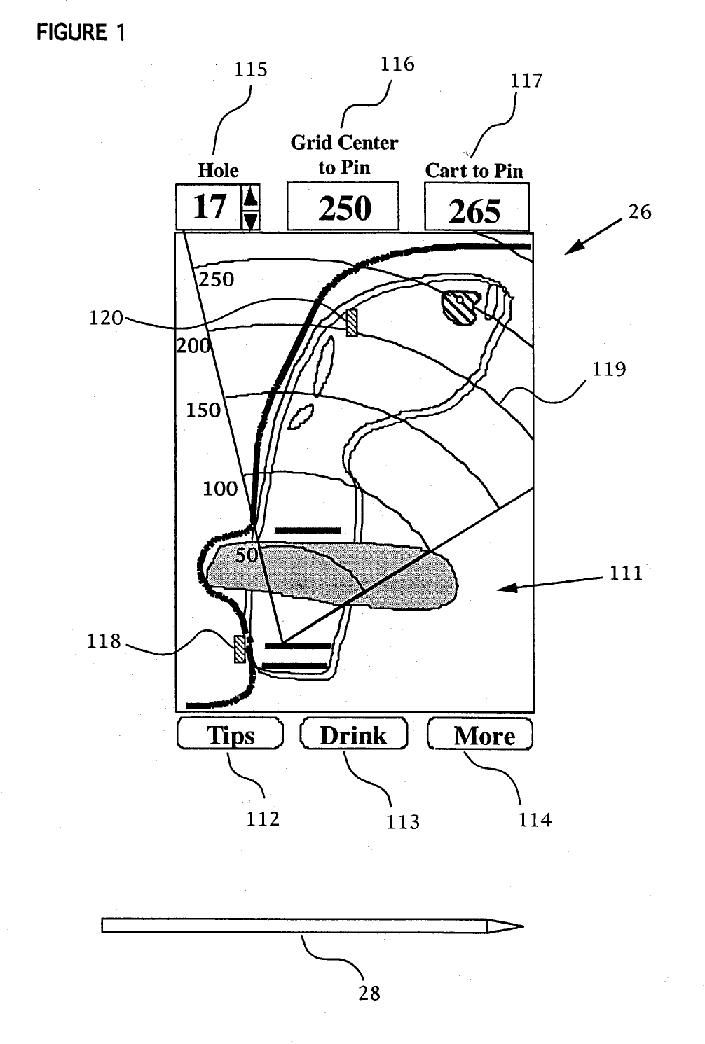

The display 26 of the preferred embodiment, illustrated in FIGS. 1 and 2, is a pen input display. The pen input display 26 is mounted on the golf cart and permits the user to directly input commands with the control device or pen 28. Preferably, the pen display 26 is a Personal Digital Assistant (PDA) such as the Apple Newton. Alternatively, the pen display 26 may comprise a pen tablet computer, either monochrome or color, such as made by Fujitsu, IBM, Toshiba, and others.

As can be seen in FIG. 1, the display 26 includes: a depiction (i.e., graphic representation) of the layout of the hole 111; option buttons 112-114; and indicators 115-117. An icon 118 represents the location of the remote unit (cart) 10 on the hole being played. A grid 119 comprising distance arcs and distance symbols (50-300 yards in FIG. 1) is overlaid on the hole layout 111. The option buttons 112-114 allow access to other functions and the indicators 115-117 display as labeled.

In FIG. 2, the packet radio system 20 is conventional, and includes modem 34, radio interface 36, and radio 38 (including an antenna, not shown). The radio system 20 is bi-directional in that it can receive error correction and other information as well as transmit present position and messages back to the base station 12. A PAC-COM, Inc. (Orlando, Fla.) packet radio modem 2400 baud for use with any commercial half duplex radio is believed preferable for the modem 34.

As an alternative to the bi-directional radio system 20 of FIG. 2, the radio system 20 may be uni-directional for simply receiving an error correction (or other message) broadcast to all remote units 10, e.g. over FM frequencies. The ACTT receiver chip set made by Seiko is believed preferably. The ACTT chip combines most of the components of the radio system 20 on a single, low cost, low power chip which is currently only a receiver. This alternative is particularly suited for hand-held remote units 10 (vice cart mounted).

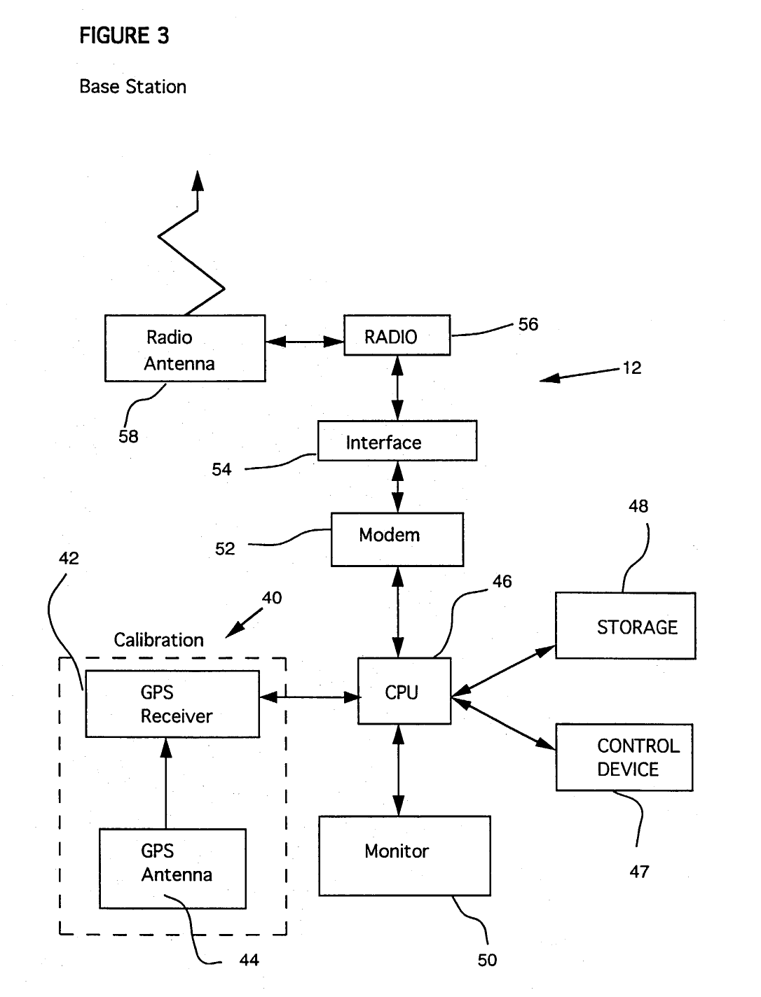

FIG. 3 illustrates the base station 12, which is desirably placed in or near the pro shop. The base station 12 includes a calibration section 40 which comprises a GPS receiver 42 and antenna 44. The calibration section 40 continuously determines apparent position of the antenna 44 and feeds this information to CPU 46. The CPU is conventional, such as a 486 type personal computer operating a 66 MHz. The control device 47 preferably includes a mouse and a standard keyboard.

The course geography database 48 is similarly connected to the CPU 46 and stores course information such as hole layout and the present position of the cups on the greens for the day. A monitor 50 is coupled to CPU 46 and is useful not only for initialization, but also is selectable to display the present position of all the remote receiver units 10 on the course. The base station 12 includes a packet radio system similar to FIG. 2 coupled to the CPU 46, and comprises modem 52, interface 54, radio 56 and radio antenna 58.

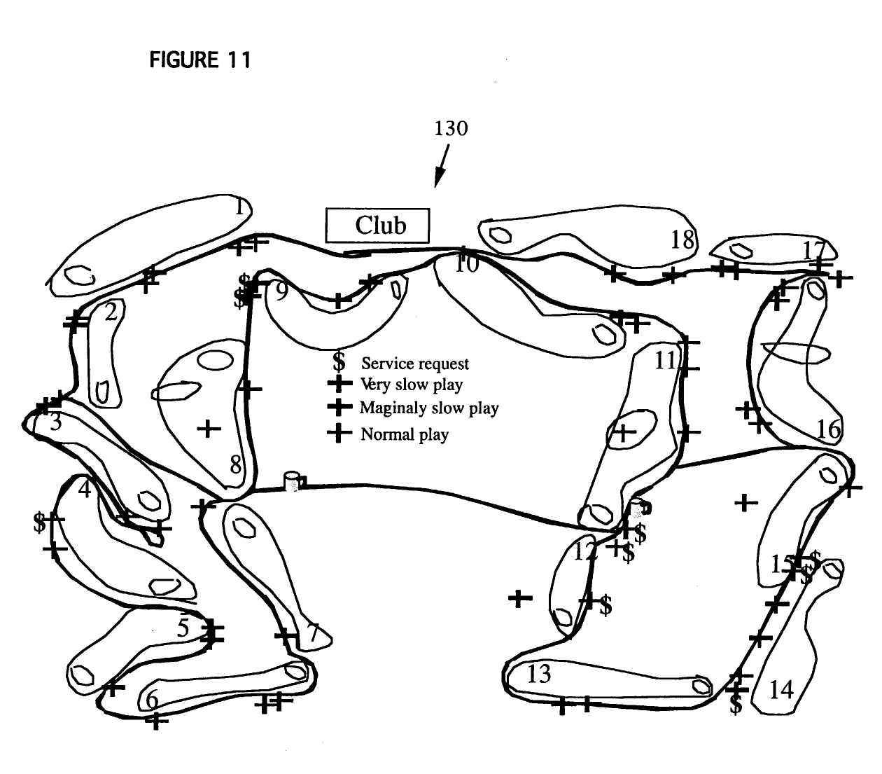

The monitor 50 is capable of displaying the golf course 130 as shown in FIG. 11. The remote units (carts) 10 are shown on the various holes and represented as “plus” icons in FIG. 11 color coded as shown. The “$” symbol represents a service request as shown, such as a cart requesting beverage service.

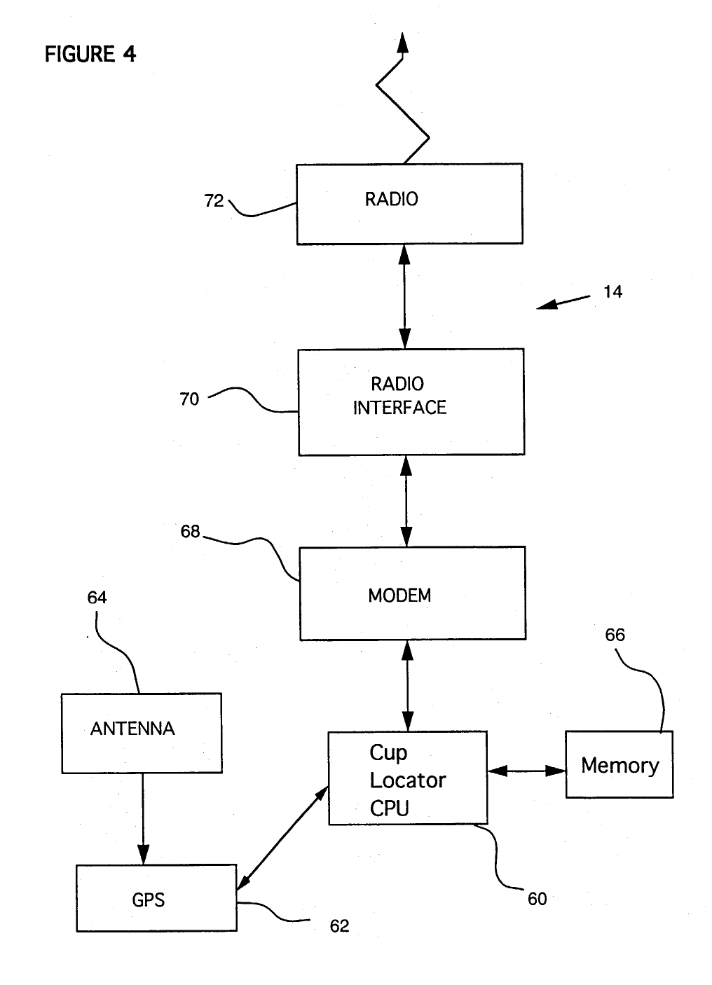

The Cup Locator 14 is illustrated in FIG. 4 and as can be seen is nearly identical to the remote unit of FIG. 2. A CPU 60 is coupled to a GPS receiver 62 which includes an antenna 64. Memory 66 is coupled to CPU 60 and stores the location of each cup as the cup locator 14 is moved from green to green. The location of each cup may alternatively be transmitted to the base station 12 using modem 68, radio interface 70, and radio 72.

### OPERATION

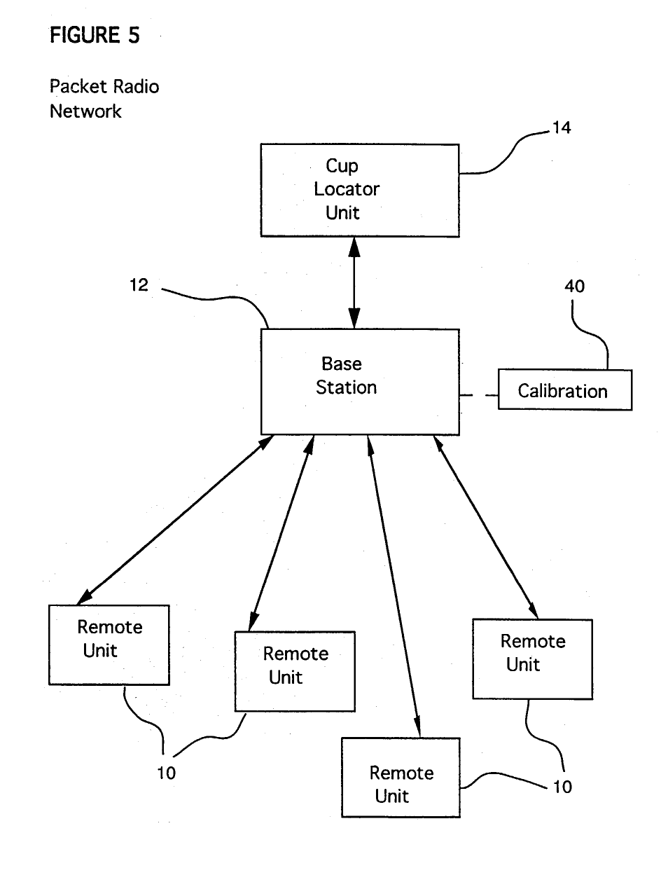

FIG. 5 illustrates schematically the operation of the system of the present invention. The cup locator unit 14 (FIG. 4) is transported from green to green when the location of the cups are changed. The greens keeper positions the cup locator unit 14 over the new cup and allows a few seconds for the GPS receiver 62 to determine an apparent cup location. The longer the greens keeper permits acquisition the more samples are obtained and accuracy is increased. The first cup might take several minutes while the GPS receiver 62 consults its almanac and locates the satellites in view, a so-called “cold start.” Determining the location of the cups should take only a few seconds to determine an apparent location once the GPS receiver 62 has operated for several minutes. Because the GPS receiver of FIG. 4 is a C/A code receiver, its accuracy is about 15 meters (selective availability disabled) with a worst accuracy of about 100 meters.

The greens keeper switches an “enter” pad (not shown) and hole number for each cup. Preferably, the timing signals from the 4-10 satellites in view are stored in memory 66 of the cup locator. Accuracy is improved by letting the cup locator 14 acquire multiple samples of each satellite timing signal. The apparent cup locations are downloaded and stored in a course geography database in the storage 48 of FIG. 3. Additionally, the course layout is stored in the database 48. After the cup apparent locations are downloaded an error correction is applied to obtain a corrected position for each cup. The corrected position is preferably transmitted over the packet radio system to update the memory 25 of each remote unit 10 before play.

In the preferred embodiment, the uncorrected or apparent cup locations are loaded into the base station computer 46 for so-called “post processing” error correction. That is, using conventional differential techniques, the timing signal for each satellite for each apparent location is compared with the same satellite timing signal for the apparent position of the base station. In this fashion, a very accurate correction for each timing signal for each satellite can be computed at the base station for the time the apparent cup locations were acquired. Each apparent cup location may have associated with it many (e.g. 4-10) satellite timing signals. Correcting these timing signals gives very accurate cup locations. Conventional surveying differential correction can achieve cup locations with an accuracy of several centimeters by looking at carrier phase and other known parameters. It is believed that simple position correction of the timing signals will achieve accuracies on the order of 0.25 meter which is believed sufficiently accurate for the present application. See e.g., Differential Correction, by Trimble Navigation (incorporated by reference for background).

Correcting the apparent cup locations as accurately as possible is advantageous. Without correction, the following error are present: satellite clock error; receiver error; atmospheric/ionispheric errors; selective availability errors (if enabled); and ephemeris errors. Because these errors change over time, it is necessary during post processing to apply the timing signal corrections for the time the apparent cup locations were acquired.

Alternatively, the apparent position of the respective cup is transmitted to the base station and also stored in memory 66. As shown in FIG. 4, the modem 68 receives the digital information representing the cup number and apparent location and modulates an analog signal with the digital information. The modulated signal passes through interface 70 to radio 72 where it is transmitted to the base station 12. FIG. 5 shows schematically the passage of the radio transmission over the packet network to the base station 12. Typically, the greens keeper would return to the base station after the cups are changed and verify that the cup information had been transmitted correctly—if not, the cup information stored in memory 66 would be downloaded to the base station 12.

In this alternative, the calibration system 40 operates to calculate and apply an error correction to the cup apparent locations as they are received over the packet radio system at the base station 12. These corrected cup locations are stored in the course geography database for later use. In this alternative method, the error is minimized by minimizing the time between acquisition and application of the error correction. By transmitting apparent cup location over the packet network and immediately applying an error correction, all GPS receivers are primarily observing the same satellites and have the same errors. Of course the post processing method of the preferred embodiment is more accurate.

As shown in FIGS. 3 and 5, during normal play the base station 12 performs continuous calibration. During calibration, the GPS receiver 42 continuously calculates its apparent position. The antenna 44 is placed at a known location. The difference between the apparent position and the known location is the current error correction. This technique is known as “differential GPS” and has been applied in land surveying techniques. Because the satellites are so high compared to the distance between the cup locator receiver 62 and the calibration receiver 44, this differential error correction accounts for most of the possible errors in the system. In the preferred embodiment, the error correction may comprise a vector or position correction which is reasonably accurate if the remote units are using the same satellites as the base station to find apparent position. Alternatively, the error correction comprises a timing correction or “delta” for the timing signals of the satellites in view. With an uncorrected accuracy of 10-15 meters, the calibrated or corrected accuracy is less than 5 meters in all cases, and normally approaches 1 meter accuracy.

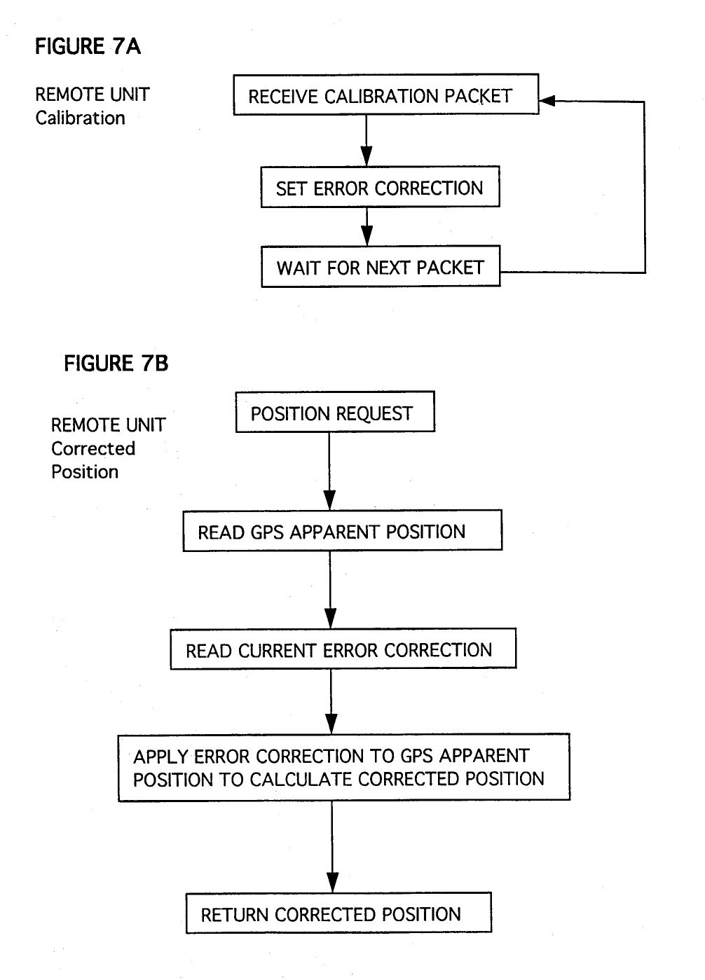

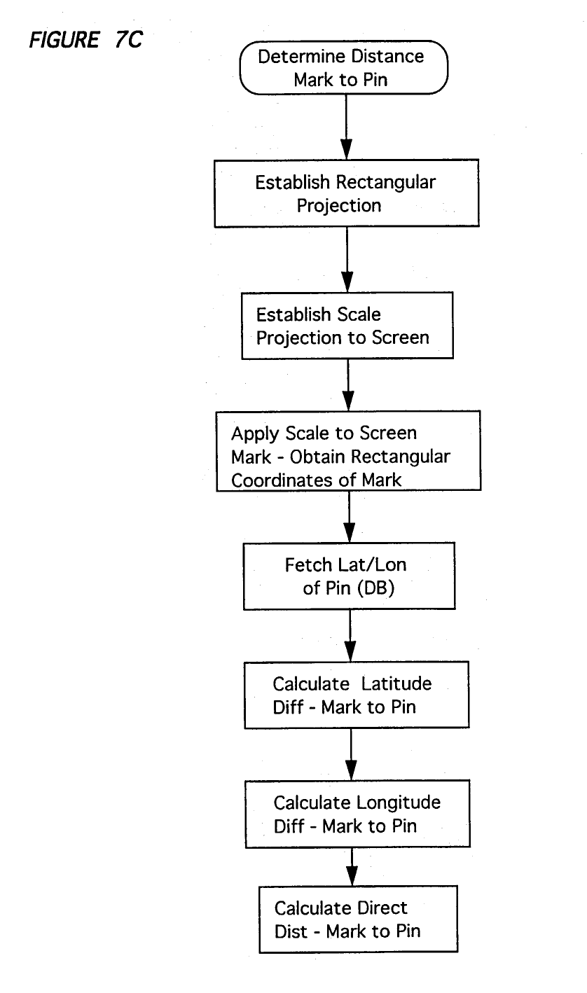

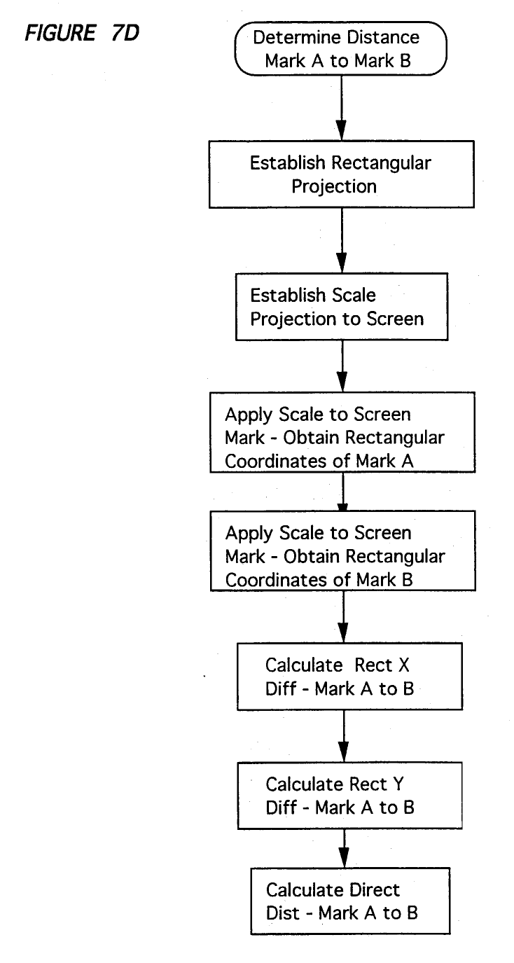

When players are on the course, the current error correction is transmitted periodically to all remote units 10 on the packet radio network (FIG. 5). Preferably, once every five to fifteen seconds a small time window (e.g. 0.5 second) is opened on each remote unit 10 for reception of the current error correction. The flow chart of the calibration software routine is illustrated in FIG. 7A where the calibrate loop is run every 5-15 seconds.

Turning to FIG. 2 the remote unit is preferably mounted on a golf cart. Current hardware technology dictates a size, weight, and power requirement that makes golf cart mounting the most feasible. However, miniaturization should enable an embodiment that is hand held in the near future.

The remote unit 10 preferably continuously operates to calculate the distance from the unit 10 to the cup on the hole being played. As shown in FIG. 7B the GPS receiver 22 determines an apparent position and then reads the current error correction stored in memory 25. The CPU 24 applies the current error correction to the apparent position to calculate a corrected position. The corrected position is compared to the corrected cup location retrieved from memory 25 and the difference is determined and shown as the distance to the pin on display 26. In the preferred embodiment the error correction comprises a number of timing signal corrections for particular satellites useful during the 15 second calibration loop. The CPU 24 applies these timing signal corrections to its apparent position timing signals.

Use of the display of FIG. 1 is matched to the players abilities. If the player does nothing, the grid 119 is displayed every time the cart (i.e. remote unit) 10 stops and has its origin at the cart. In this case, both indicators 116 and 117 display the same number which is the distance from the cart to the cup location. By looking at the grid, the player can also tell approximate distances t6 other features, such as the distance to carry a hazard or to lay up short of a hazard. The cart symbol 118 is always present and shows the position of the cart on the hole layout 111. The player need to touch the arrows of the “Hole” indicator 115 with the pen 28 to increment (or decrement) the hole being played—i.e. when hole 17 is complete the player touches the top arrow of indicator 115 to increment and display hole 18.

The preferred embodiment employs a method to determine if the cart is stopped. If the cart is stopped, the grid 119 snaps onto the display and the cart (remote unit 10) does not re-transmit its location to the base station 12 (to reduce bandwidth requirements). Additionally, when stopped, the GPS receiver 22 may begin averaging apparent position measurements to obtain a more accurate “apparent position.” The method to determine if the cart is stopped compares the apparent positions of the cart (typically 2 samples) to the selective availability error (Derror). If both samples are within 1 meter, then the cart is assumed to be stopped. Selective availability error (Derror) is believed to be not more than 1 meter per 5 seconds and although random, if a cart is stopped the 2nd sample would be within 1 meter of the 1st sample if the cart is stopped. If the 2nd sample is greater then 1 meter, then the cart is assumed to be moving and the 2nd sample becomes the new current apparent position.

If the player chooses to use the expanded features, more options are available. If the player touches the hole layout 111 with the pen 28 the grid snaps to the location touched and the indicator 116 indicates the yardage to the pin from the apex or origin of the grid. In FIG. 1, the player has touched the middle tee box (where the player will place the ball) to more accurately judge distances to hazards. This feature is particularly useful for hole, shot planning, or estimating driving distance. For example, the player might touch the hole layout 111 between the 150 and 200 yard grid arcs to determine a target 110 yards from the pin for hitting the player's next shot.

Another feature is the icon 120 depicting the nearest cart of the group playing ahead. As can be seen, the icon 120 is about 230 yards ahead, so tee-off can safely be made if no club is expected to approach the 230 yard distance. This ability to determine distance to the cart ahead speeds up play while preserving game etiquette, and is particularly useful where the cart ahead cannot be seen, so-called blind holes. The preferred embodiment simply shows all carts (remote units) 10 on the hole being played.

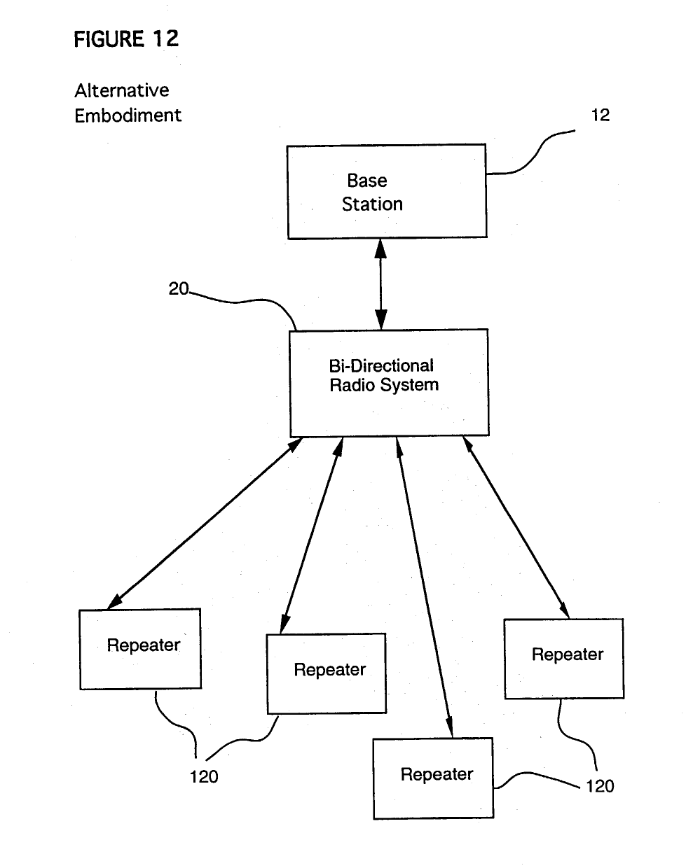

The option buttons 112-114 allow the player to access “tips” (e.g. caddie hints), “drinks,” and “more” respectively. The tips are just that—memory storage 25 contains caddie hints for the current location of the cart. For example, here the hint might state “aim between the far trap and the green and carry the trap”. The “more” menu allows the player to access other options, such as a scorecard where the player can enter scores for the round for each player or food service. If desired, the scores can be transmitted over the radio network and downloaded to the base station 12 for handicap input and is particular useful during tournaments. The “drink button allows the player to order drinks, either for immediate delivery. As shown in FIG. 12, if a player requests immediate food or beverage, the monitor 130 reflects the request and the delivery person can be dispatched.

FIG. 7C illustrates the flow chart for determining the distance from the mark “A” to the pin (e.g. FIG. 11), while FIG. 7D depicts the determination of the distance from mark “A” to mark “B”. The method for determining the distance from the remote unit 10 to the mark “A” is almost identical to the method of FIG. 7C with the position of the cart compared to the Mark coordinates instead of the position of the pin.

The accuracy of determining a distance to a “mark” or between “marks” is dependent upon screen resolution. There are several conventional methods for .determining distance between marks on a screen or monitor, with FIGS. 7C and 7D illustrating one approach. A rectangular projection is defined as a grid encompassing the entire hole being played with the latitude and longitude of an origin (e.g. lower left corner) defined. The units of the rectangular projection are real numbers that correspond to actual distances from the origin.

The pixels on the screen (SP) can be mapped to the rectangular projection points (RP) as:

| | |
|---|---|
| RP = m SP + b | RP = m SP + b |
| where | |
| m = dx | m = dy |
| b = dx − m dS | b = dy − m dS |

Several methods are available for determining the distance between the marks or the pin or cart to a mark. In a preferred method, the mark and coordinates of the cart (for example) are converted to radians in meters from an origin (such as the prime meridian and equator).

Alternatively, the distance form mark A to the cart can be determined trigonometrically. The distance between the cart and pin are known and the angle between the cart/pin vector to the cart/mark vector can be ascertained from the screen. The magnitude of the cart/mark vector can be determined.

In the preferred embodiment the remote unit 10 calculates and displays a distance from the unit 10 to the cup (or an arbitrary green location), it receives a current error correction every 5-15 seconds, and additionally, transmits a current position to the base station every 5-15 seconds. This allows the course marshal or pro to view the monitor in FIGS. 3 and 12 to consider the position of every remote unit on the course.

### SECOND EMBODIMENT

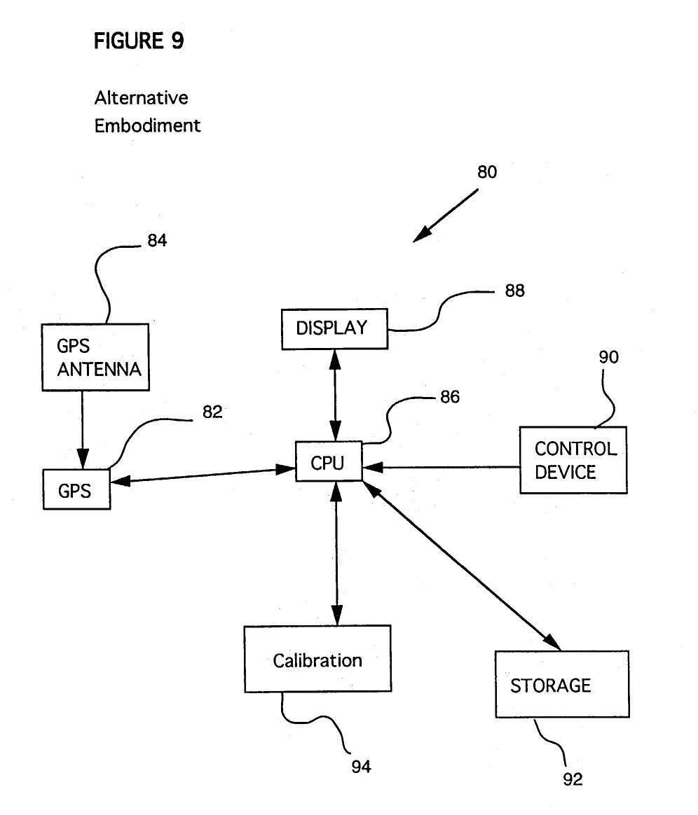

FIG. 9 illustrates an alternative embodiment remote unit 80 which is preferably mounted on a golf cart or hand carried. In the system of FIG. 9 the base station is eliminated as well as the packet radio system. The remote unit 80 includes a GPS receiver 82, GPS antenna 84, CPU 86, display 88, control device 90, storage 92 and calibration 94. The hardware may be the same as in the preferred embodiment but for the hand carried remote unit power requirements is a factor in hardware selection.

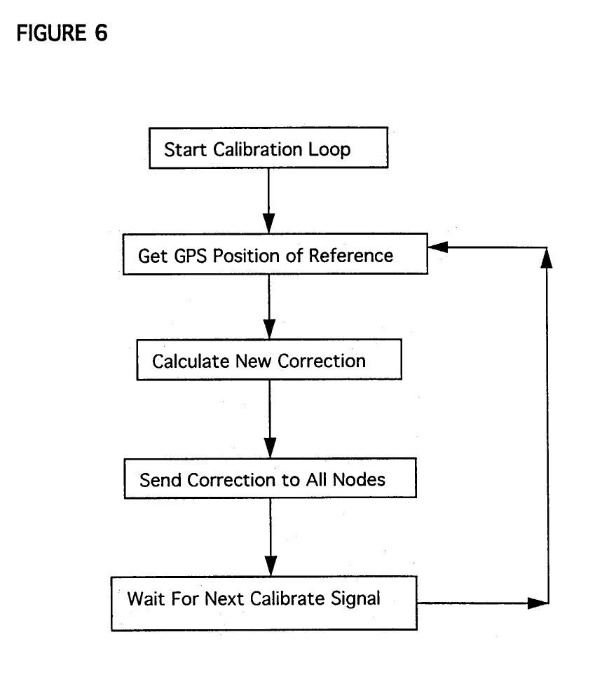

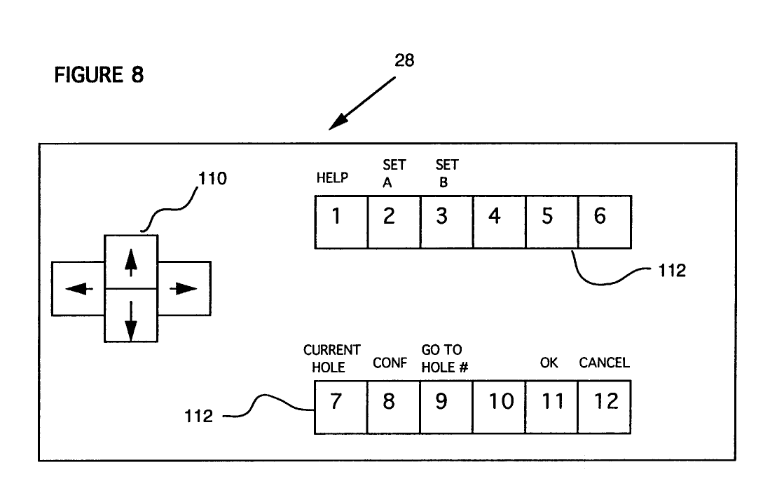

In particular, the storage 92 similarly contains a course geography database, but in addition contains the location of a calibration location for each hole. Such a calibration location is preferably a placard on the ground in the cart path adjacent the tee box for the hole being played. In the alternative embodiment, a control device like FIGS. 1 or 8 is used with keypad “6” being additionally labeled with the notation “Calibrate.” The calibration box 94 in FIG. 9 is preferably EEPROM and contains the calibration routine of FIG. 6. Of course the calibration routine could alternatively be stored in Storage 92.

In use, the present position of the cups for each hole is loaded in the course geography database in storage 92. Preferably the cup locator of FIG. 4 is used with the packet radio system eliminated. The cup locations are stored in memory 66 and transferred to the remote unit 80. Without calibration and with a C/A code receiver 82, the remote unit 80 will give distance accuracies within 100 meters (S/A enabled) and within 20 meters (S/A disabled). Of course technical improvements in GPS technology might improve on this accuracy to some degree.

To improve these accuracies a calibration procedure is utilized. The golfer places the remote unit 80 over a placard in the cart path, calls up the display for the hole being played, and presses “Calibrate” pad 6. The routine of FIG. 6 is initiated, and an error correction is determined by comparing the current apparent GPS position with the GPS position stored for the hole placard. This calibrate procedure gives a reasonably accurate error correction for the duration of play for the hole. If a player forgets to calibrate for a hole the previous error correction is simply carried over and applied.

Accuracy is largely dependent on the desires of the golfer. With Selective Availability disabled (or perhaps with a wide area differential correction or pseudolite) accuracy within 1 meter should be possible on most holes if a calibration is performed every hole. If the system is calibrated by the pro shop before play, accuracy is estimated to be quite good (e.g. <3 meters) for several hours until new satellites come into view and use.

### THIRD EMBODIMENT

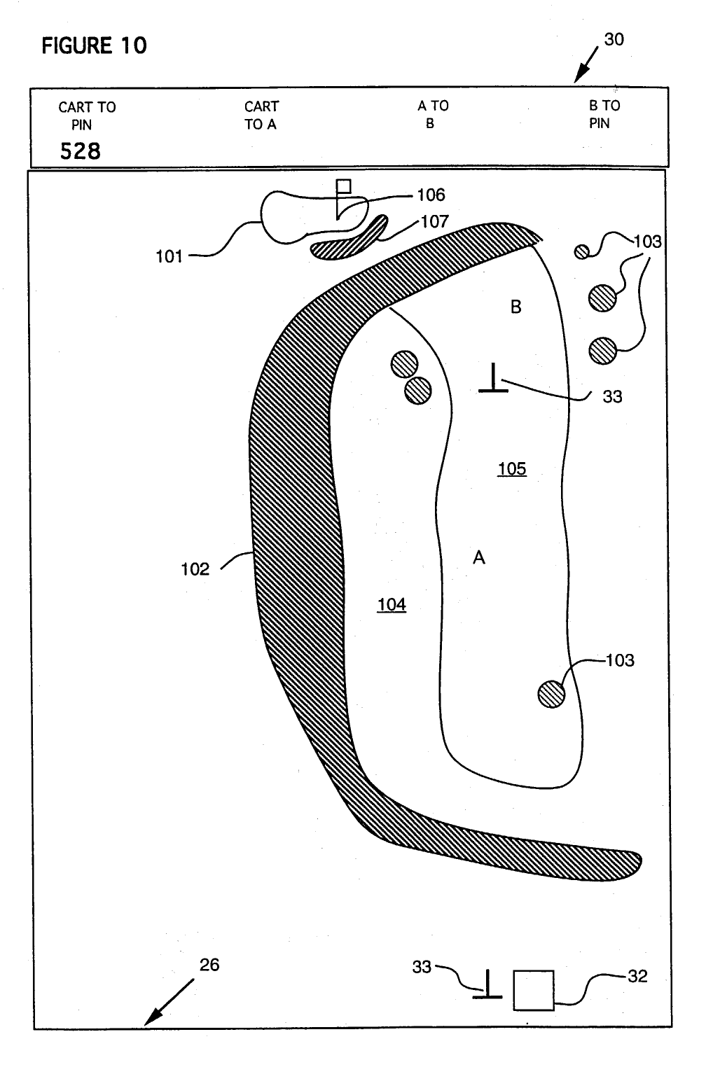

The display 26 of FIG. 10 is preferably a 640×480 pixel LCD supertwist, ISA bus compatible display, but other conventional types of displays are operable. The display depicts the layout of the hole being played, as well as a distance box 30 and present position icon 33. The CPU 24 is preferably an 8088 CMOS microprocessor operable at 10 MHz and ISA bus compatible. A control device 28 is coupled to the display 26 so that the player can optionally position one or two markers on the hole layout.

FIG. 8 illustrates one embodiment of the control device 28. The four direction keys 110 are used for marking locations on the hole (see FIG. 10, marks A and B). The twelve function keys 112 operate to function as labeled. While a pen based control system might be preferable functionally to the device 28 illustrated in FIG. 8, cost considerations prompted the choice of the device 28.

The storage 25 is preferably includes nonvolatile memory which stores a database of the hole layouts, as well as the corrected location of the cup on each hole. Battery backed-up RAM is preferred, but other alternatives are operable and offer some advantages, such as a WORM optical disc coupled to RAM or EEPROM. Volatile memory stores the current error correction.

FIG. 10 illustrates operation of this embodiment. In FIG. 10, the far left space in box 30 shows the distance from the remote unit 10 to the cup. Preferably, the remote unit 10 is placed as close as possible to the ball so the distance readout in box 30 “CART TO PIN” is an accurate reflection of the distance of the ball to the pin.

The player can also visually track the progress of the icon 33—representing the remote unit 10 as the golf cart progresses on the hole layout from tee 32 to green 101. For shot planning, the player can mark a location (e.g., “A”) on the display 26 using the pointing device 28. The CPU calculates an approximate distance from the icon 33 to the mark “A” and displays the distance to the player in the space of box 30 labeled “CART TO A”.

For example, FIG. 10 represents a 520 yard par 5 with water 102 on the left side and in front of an elevated green 101. Trees 103 in the rough 104 and the fairway 105, as well as a trap 107 in front of the green are factors. If the player hits to position A and positions the remote unit 10 near the ball, the far left space in box 30 might read 230. This does not necessarily mean the player hit a 290 yard drive.

The 230 yard reading is the direct line from the remote unit 10 (adjacent the player's ball) to the cup 106, which is placed at the front of the green 101. Additionally, the tee markers might have been placed forward of the nominal 520 yard placard.

The player might mark the display 26 at position B with the pointing device 28. The far right space on box 30 labeled “B TO PIN” would read the approximate distance 175. The preferred embodiment is configured such that if the player marks “B” with the pointing device 28, both the approximate distance from the cup/pin 106 to position B as well as the approximate distance from “A” to “B” is shown in box 30. This feature allows a player to quickly and effectively consider his options—for example the player might attempt a fairway wood from “A” to the green 101 or layup to position B for a wedge to the length of the green 101.

### FOURTH EMBODIMENT

This embodiment is illustrated in FIG. 12. The GPS “engine” is eliminated in the remote units. Rather, each remote unit 10 comprises a GPS repeater, such as a Tidget GPS sensor made by Navsys Corp. of Edinburgh, Scotland. The repeater 120 operates to receive the GPS raw data timing signals from the GPS satellites, digitize and compress the timing signals. Preferably, the repeater 120 can be set to look at a certain number of satellites, e.g. 5 satellites. The satellite timing signals are not processed. Instead, the signals are amplified and periodically relayed to the base station 12. Different signal processing techniques may be employed if desired, such as filtering and compressing. The base station collects each timing signal from the repeaters and processes the timing signals to determine a location of the repeater.

The base station 12 can employ the amount of processing desired to the timing signals to improve the accuracy estimation of the repeater—commensurate with the time available, the processing load, accuracy desired, etc. If desired, a distance to the green cup for the repeater can be transmitted and displayed on the cart of the repeater.

In FIG. 12 a preferred embodiment of such a repeater system is illustrated. Each repeater 120 includes an identification. Each repeater 120 is allocated, for example, an 80 millisecond transmit and a 20 millisecond receive time window. Because the base station 12 and all of the repeaters 120 have accurate GPS timing signals, such a time window allocation is possible. A repeater 120 receives timing signals from 4 satellites and stores the signals in a temporary memory buffer (compressing if desired) for transmission in its allocated time window. The timing signals include an identification of the satellite.

The base station 12 receives the timing signals from a certain repeater 120 in the repeater's allocated timing window. The base station has already coprocessed a timing correction for each satellite timing signal, and therefore can apply the correction upon receipt of the repeater timing signal. The repeaters 120 are receiving the timing signals from predominantly the same satellites, so the base station needs to only keep a current correction for a limited number of satellites. Using the corrected timing signals, the base station can accurately process the repeater timing signals to derive a location of the repeater on the golf course.

This embodiment uses the repeater location and compares the location with a database of golf cup locations (or an arbitrary location on the green such as center of the green). The difference is the distance from the repeater 120 to the cup location. This distance is transmitted to the repeater 120 in the 20 millisecond time window allocated for that repeater. The distance is displayed on the cart to give the golfer a distance to the pin estimation.

This embodiment contemplates the use of time windows to avoid the communication overhead associated with hand shake protocols. With this method, it is believed that repeaters on 50 carts may transmit their timing signals and receive a distance to the pin estimation with an update rate every 5 seconds. From the golfers perspective, a new distance to the cup estimation is displayed every 5 seconds. In the pro shop, the position of the carts on the course is refreshed every 5 seconds.

Alternative configurations of this embodiment exist in many forms. For example, the repeater may take the form factor of a digital pager and even be hand carried. Additionally, instead of allocating time windows, the repeater 120 may include a query button which upon activation by the golfer transmits the latest satellite timing signals which are immediately processed and the distance estimation returned.

It should be readily apparent that a primary advantage of this embodiment is reduced cost of the remote receiver hardware. A repeater with a communications link and a simple LED display is all that is required as the remote unit. Another advantage is the small size possible and reduced power requirements. Disadvantages are the processing load required at the base station, a heavy communications load, and the dependence on the communications link.

### FIFTH EMBODIMENT

With the advent of inexpensive higher resolution displays, this embodiment contemplates distance estimations from the remote unit to the golf cup location without the use of GPS or other location identifier (e.g. Loran or radio triangulation) in the remote unit. A pen display such as shown in FIG. 1 is used, preferably with a resolution greater than 1020×680 pixels. For a 500 yard golf hole length, this gives about 2 pixels per yard; for a 200 yard golf hole there are about 5 pixels per yard.

For example on the 500 yard golf hole, the golfer is about 200 yards from the green and accordingly touches the display with the pen at the approximate location of the ball on the display. The display immediately zooms to include the portion of the golf hole from the green to the designated location plus about 10%. In this example, the portion of the golf hole display after the zoom is approximately 220 yards. With the new 220 yard display, the golfer can redesignate the location of the ball on the display with the pen 28. The redesignation is obviously more accurate because there are now about 5 pixels per yard. Golfers can be expected to designate their position on a display within 20 pixels, so the error in designation is within 4 yards.

To improve accuracy, the location of the golf cup on the green is preferably loaded into a database in the remote unit. That is, a GPS unit is used to survey the location of the golf cup on the green within 1 yard and this database is loaded whenever the location of the cups are changed. If center of the green locations are used as nominal cup locations, accuracy is degraded.

Alternative Embodiments

Other alternatives are of course possible. By way of nonlimiting example, the display 26 can be replaced with a simple LED which only displays distance from the remote unit to the cup. Additionally, the cup locator unit 14 can be eliminated with the greens keeper simply manually entering the approximate grid coordinates of each cup into the base station 12. Obviously, if the course does not want to set in the approximate grid coordinates of each cup, a nominal grid coordinate, e.g. center or front of the green, can be entered for each green, but accuracy is obviously reduced. The term “cup position” or “cup location” should be understood to include a measured location or a static grid location, such as nominally the center of the green. The terms “cup” and “pin” are often used interchangeably in this application. “Global Positioning Satellite System” includes the U.S. Navstar system, the Russian Glonass, and future analogous systems, such as the proposed system of the European Community.

1. An apparatus for determining the approximate distance to a feature on a golf hole comprising:
memory means for storing a map of a golf hole and a position for at least one feature on said golf hole;
a GPS receiver means positionable on the golf hole for receiving signals from a GPS system and for determining the location of said GPS receiver means using said signals;
a reference receiver means positioned at a known position for receiving signals from said GPS system to determine an apparent reference position;
error correction means for determining an error correction based on a difference between said known position and said apparent reference position;
processing means communicating with said error correction means, said memory means and said GPS receiver means to determine an approximate error corrected distance from said GPS receiver to said position of said at least one feature;
display means for depicting said map of said golf hole and said at least one feature; and
grid means depicted on said display means with an origin at said GPS receiver means location and including a distance indicator showing said approximate error corrected distance from said origin to said at least one feature.

2. A system for monitoring golfers on a golf course, comprising:
a plurality of remote receivers adapted to accompany respective golfers on said course, each remote receiver having
a GPS receiver for receiving information from a Global Positioning Satellite System, and
a transmitter for transmitting location information of the receiver on the golf course; and
a base station having a receiver which receives the location information of the remote receivers and a display for displaying the location of the plurality of remote receivers on the golf course.

3. The system of claim 2, the base station including a transmitter for transmitting messages to the remote receivers and the remote receivers having a receiver for receiving said messages.

4. The system of claim 2, each remote receiver including a radio for receiving error correction information and a processor for applying the error correction information to the location information to determine a corrected location of the receiver.

5. The system of claim 2, each remote receiver including a radio for receiving other information broadcast from the base station.

6. The system of claim 5, said other information comprising a slow play warning sent to a specific remote receiver.

7. The system of claim 2, each remote receiver including a user interface to input golf score information and said transmitter operable to transmit the golf score information.

8. The system of claim 2, each remote receiver including a user interface to input food order information and said transmitter operable to transmit the food order information.

9. A method of tracking golfers on a golf course comprising the steps of:
providing a remote receiver to one or more golfers, each remote receiver having an apparatus for determining the location of the remote receiver on the golf course, including an input for GPS data;
operating each remote receiver to determine the location of the remote receiver on the golf course, including the substep of receiving a GPS input;
moving the remote receivers on the golf course as each remote receiver accompanies a respective golfer;
transmitting the location of one or more of the remote receivers;
receiving at a base station the location of said one or more remote receivers; and
displaying at the base station the location of said one or more remote receivers on the golf course.

10. The method of claim 9, including the steps of transmitting a message from the base station to a particular remote receiver, receiving the message at the particular remote receiver, and displaying the message at the particular remote receiver.

11. The method of claim 9, including the steps of transmitting a message from the base station to a number of remote receivers, receiving the message at said number of remote receivers, and displaying the message at said number of remote receivers.

12. The method of claim 9, including the steps of transmitting a message from a particular remote receiver, receiving the message at the base station, and displaying the message at the base station.

13. The method of claim 12, including the step of transmitting a message indicative of the score of the golfer accompanied by the particular remote receiver.

14. The method of claim 9, including the step of transmitting a food order message from a particular remote receiver.
